(19) United States
(12) Patent Application Publication
(10) Pub. No.: US 2002/0056953 A1
(43) Pub. Date: May 16, 2002

(54) Shock-absorbing mount

(75) Inventor: Michael Burns Williams, Lake Oswego, OR (US)

Correspondence Address: KOLISCH HARTWELL DICKINSON MCCORMACK &, HEUSER, 520 S.W. YAMHILL STREET, SUITE 200, PORTLAND, OR, 97204, US

(73) Assignee: R.M. Wade & Co.

(21) Appl. No.: 10/010,006

(22) Filed: Nov. 9, 2001

Related U.S. Application Data
(60) Provisional application No. 60/249,102, filed on Nov. 15, 2000.

(51) Int. Cl. F16F 9/00; F16F 15/00

(52) U.S. Cl. 267/140.13

(57) ABSTRACT

A shock-absorbing mount to attach an exhaust assembly to a vehicle and to dampen forces through this attachment, and a method for fabricating the shock-absorbing mount. The shock-absorbing mount includes a housing with a side wall portion joined to an end cap. A cushion is positioned at least substantially within the housing. The cushion is at least partially spaced from the end cap to form an interior compartment. A displaceable member is affixed to the cushion, extending away from the end cap. The housing and displaceable member may be attached individually to either the vehicle or the exhaust assembly to dampen forces relative to each other through deformation of the cushion.

### CROSS-REFERENCE TO RELATED APPLICATIONS

This application is based upon and claims benefit under 35 U.S.C. § 119 from the following U.S. Provisional Patent Application, which is incorporated herein by reference: Serial No. 60/249,102, filed Nov. 15, 2000.

### FIELD OF THE INVENTION

The invention relates to a shock-absorbing mount that may be used for attaching an exhaust assembly to a vehicle and for dampening movement of the exhaust assembly relative to the vehicle.

### BACKGROUND OF THE INVENTION

A vehicle traveling along a road is subjected to numerous sudden forces. These potentially damaging forces include sudden turns, braking, travel over uneven road surfaces, and collisions with other vehicles or objects. The vertical, horizontal and even rotational forces placed on a vehicle in motion must be uncoupled from, or at least dampened by, force absorbing systems such as shock absorbers to prevent structural damage to force-sensitive vehicle components, including the driver and passengers. In addition, shock-absorbing mounts are essential to minimize damaging movement of mounted vehicle components and to provide a quieter driving environment.

The exhaust system of a large truck plays a critical role in noise reduction, exhaust removal, and engine function. Typically, the fumes and particulates are diverted by exhaust pipes, which travel vertically up the rear corner of the truck cab. This placement facilitates exhaust emission at a level above most traffic, minimizing the immediate impact on other drivers.

Large trucks have noisy engines and braking systems, so a noise reduction system, a muffler, is included in the exhaust system to reduce noise for both the driver and the community. Nevertheless, the benefits of a muffler come with a price. The large size of an efficient muffler, along with the large diameter of exhaust pipes found on heavy trucks, provides a very heavy exhaust assembly to be mounted on the truck. Brackets strong enough to stably attach the exhaust assembly to the truck cab are available, but they create tension between the exhaust assembly and the truck cab. Specifically, the exhaust assembly is attached to the engine, so that engine vibration relative to the cab will tend to jar the exhaust assembly loose and damage it structurally. Furthermore, this vibration is transferred to the truck cab, creating a noisier, less relaxing atmosphere for the driver. Therefore, a system to absorb this relative movement is required.

A currently used device that attempts to dampen vibration of an exhaust assembly relies on the compressibility of rubber. This device sandwiches a compressible rubber biscuit between brackets or bracket extensions contributed by the truck cab and the exhaust assembly. Although better than a direct metal-on-metal connection, the inability of the rubber to deform significantly under force in this device prevents effective isolation of the exhaust assembly relative to the cab. This results in a noisier and less comfortable driving environment for the truck driver. Therefore, an effective mounting device is required that is capable of attaching an exhaust assembly to a vehicle and effectively isolating or dampening forces exerted on the exhaust assembly or the vehicle.

### SUMMARY OF THE INVENTION

The invention provides a shock-absorbing mount to attach an exhaust assembly to a vehicle and to dampen forces through this attachment, and a method for fabricating the shock-absorbing mount. The shock-absorbing mount includes a housing with a side wall portion joined to an end cap. A cushion is positioned at least substantially within the housing. The cushion is at least partially spaced from the end cap to form an interior compartment. A displaceable member is affixed to the cushion, extending away from the end cap. The housing and displaceable member may be attached individually to either the vehicle or the exhaust assembly to dampen forces relative to each other through deformation of the cushion.

### BRIEF DESCRIPTION OF THE DRAWINGS

FIG. 1 is a side elevation environmental view of two shock-absorbing mounts constructed in accordance with the present invention, connecting an exhaust assembly to a vehicle cab.

FIG. 2 is an isometric view of an embodiment of a shock-absorbing mount constructed in accordance with the present invention.

FIG. 3 is a sectional isometric view of the shock-absorbing mount of FIG. 2, viewed generally along line 3-3.

FIG. 4 is a side view in partial cross section of the shock-absorbing mount of FIG. 2 in a resting position, connecting an exhaust assembly to a vehicle cab.

FIG. 5 is a side view in partial cross section of the shock-absorbing mount of FIG. 4, responding to a downward force.

FIG. 6 is a side view in partial cross section of another embodiment of a shock-absorbing mount constructed in accordance with the present invention.

FIG. 7 is a partially cross-sectional, fragmentary side view of another embodiment of a shock-absorbing mount constructed in accordance with the present invention, showing an alternative approach to attachment of an end cap.

FIG. 8 is a partially cross-sectional, fragmentary side view of another embodiment of a shock-absorbing mount constructed in accordance with the present invention, showing another alternative approach to attachment of an end cap.

FIG. 9 is a partially cross-sectional, fragmentary side view of another embodiment of a shock-absorbing mount constructed in accordance with the present invention, showing another alternative approach to attachment of an end cap.

FIG. 10 is a partially cross-sectional, fragmentary side view of another embodiment of a shock-absorbing mount constructed in accordance with the present invention, showing an end cap formed integrally.

FIG. 11 is a partially cross-sectional, fragmentary side view of another embodiment of a shock-absorbing mount constructed in accordance with the present invention, showing an alternative approach to forming a first end region of the housing.

FIGS. 12A, B, and C illustrate a method of fabricating an embodiment of a shock-absorbing mount according to the present invention, with each step shown as a side view in partial cross section.

FIG. 13 is a diagram presenting force-displacement values that were produced by a specific embodiment of a shock-absorbing mount constructed according to FIG. 6.

### DETAILED DESCRIPTION

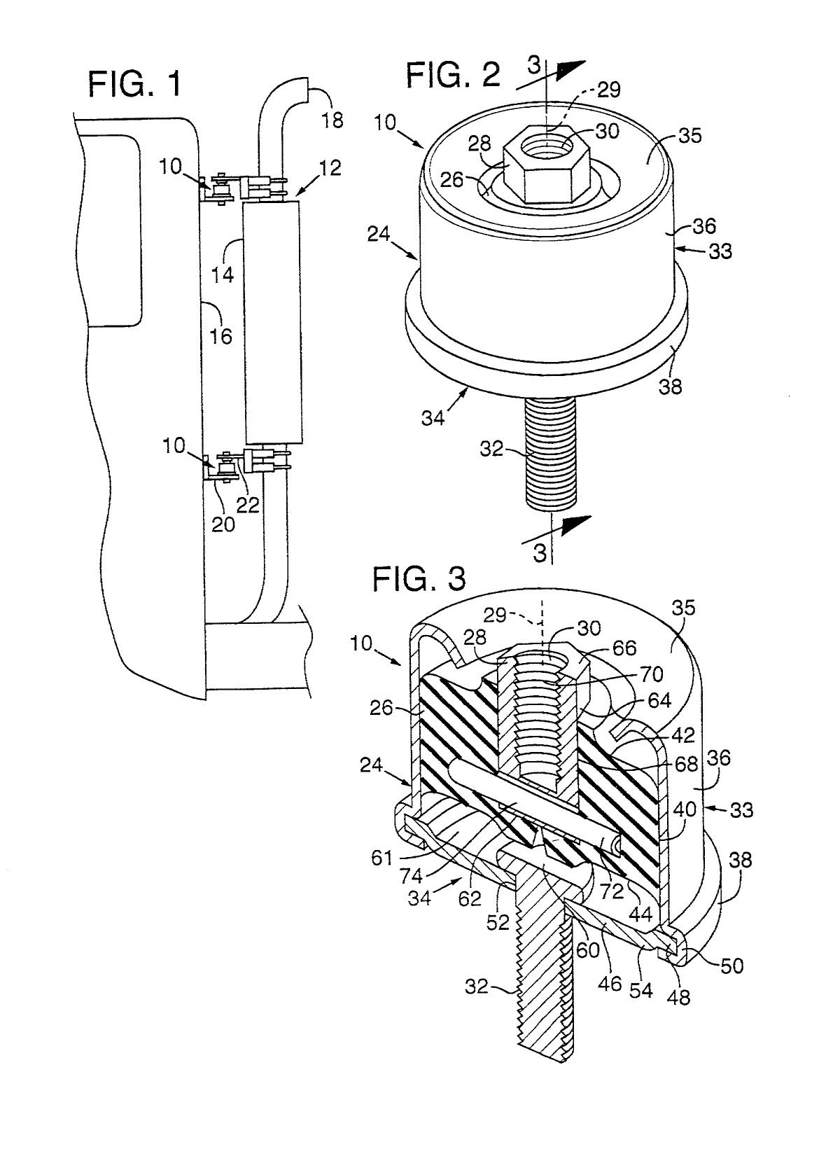

The present invention is directed to a shock-absorbing mount, such as the embodiment depicted in FIGS. 1-5 and identified generally with the numeral 10. The depicted shock-absorbing mount 10 provides a mechanism for coupling first and second external structures so that a force exerted on the first structure is at least partially isolated from the second structure. For example, as shown in FIG. 1, shock-absorbing mount 10 may be used to isolate movement and vibration of an exhaust system relative to a vehicle cab. In this example, an exhaust assembly 12, including a muffler 14, is attached vertically along the rear of a vehicle cab 16. Exit of exhaust gases occurs at an upper end 18 of exhaust assembly 12, above the cab. A pair of shock-absorbing mounts 10 is positioned adjacent assembly 12, with each shock-absorbing mount connected to vehicle cab 16 and the assembly 12 with bottom and top brackets 20 and 22, respectively. The configuration depicted allows exhaust assembly 12 to be mounted on vehicle cab 16 through shock-absorbing mount 10, which generally acts to unlink vibrations and other potentially damaging or irritating movements of exhaust assembly 12 relative to the vehicle cab.

In the example shown, a first end of each shock-absorbing mount 10 is connected to exhaust assembly bracket 22, adjacent to muffler 14, and a second end is connected to vehicle cab 16 through vehicle cab bracket 20. However, alternative attachment configurations may be used as well. For example, attachment sites of shock-absorbing mount 10 relative to vehicle cab 16 and exhaust assembly 12 may be reversed, that is, the cab may be connected to the first end of the shock-absorbing mount, whereas exhaust assembly 12 may be connected to the second end. Furthermore, shock-absorbing mount 10 may be inverted relative to the orientation illustrated in FIG. 1, or shock-absorbing mount 10 may function in a non-vertical orientation, for example, when an exhaust assembly is mounted horizontally along a bottom region of a truck cab. It will be understood that the exhaust assembly and truck cab are exemplary attachment structures only.

FIGS. 2 and 3 show isometric views of shock-absorbing mount 10. A shock-absorbing mount generally includes a housing 24, an elastomeric cushion 26 positioned substantially inside housing 24, and displaceable member 28, which is attached to elastomeric cushion 26 and may be substantially aligned with central axis 29. Displaceable member 28 may provide member fastener 30 and housing 24 may provide housing fastener 32. Fasteners 30 and 32 typically extend in generally opposite directions and may be aligned with central axis 29. Fasteners 30 and 32 may be used to attach shock-absorbing mount 10 to first and second external structures and thus couple the external structures to each other. In the example of mount 10, fastener 30 is a nut and fastener 32 is a bolt. When the fastener structures are connected to first and second external structures, a force exerted on member 28, such as a force generally downward and parallel to central axis 29, causes member 28 to move relative to housing 24 by structurally altering (deforming) elastomeric cushion 26. Elastomeric cushion 26 thus facilitates isolating forces exerted on either housing 24 or member 28.

The housing may take a number of different forms. A housing is any structure capable of at least substantially containing an elastomeric cushion within an interior space, fixedly positioning a peripheral portion of the elastomeric cushion relative to the housing, and may provide a fastener for coupling to an external structure. The housing may include a generally cylindrical region with substantially parallel side walls, such as shown in FIGS. 2 and 3. Alternatively, the housing may adopt other cross-sectional geometries, such as oval, or polygonal, or a combination of these geometries. Although a rigid polymeric material may be used, the housing is typically constructed of malleable, non-corrosive, high-strength material, and thus may be formed at least substantially of metal or a metal alloy. A suitable material that has been used successfully is mild steel that is Aluminized, Aluminum Killed, and Deep Draw quality.

As shown in FIGS. 2-5, housing 24 may be generally cup-shaped, defined by a side wall portion 33 and an end cap 34 joined to the side wall portion. Side wall portion 33 may be formed integrally and may include a first end region 35, a central region 36, and a second end region 38. The first end region may generally converge by extending inward, toward the central axis, as shown for first end region 35 in FIGS. 2 and 3. Alternatively, the first end region may extend parallel to the central region or flare outward. Side wall portion 33 surrounds the central axis, providing an interior space or void in conjunction with end cap 34. Side wall portion 33 also provides an interior surface 40 that engages elastomeric cushion 26, typically through adhesive bonding between housing 24 and cushion 26 or through engaging physical contact. Physical contact may be more effective when the side wall portion includes an irregular interior surface that is engaged by the cushion. For example, the side wall portion may include a dimpled or other uneven surface on at least part of the interior surface. As an alternative to engagement by central region 36, the first and second end regions of side wall portion 33 may be configured to engage a peripheral region of the elastomeric cushion provided by top surface 42 or bottom surface 44 of cushion 26.

End cap 34 of housing 24 may play at least several roles in shock-absorbing mount 10. End cap 34 may include housing fastener 32 for securing mount 10 to an external structure. As shown in FIGS. 2-5, housing fastener 32 may be threadable, such as the bolt shown, or a nut. Alternatively, fastener 32 may indirectly function as a fastener by including attachment structure such as a bracket that may be connected through a separate fastener to an external structure.

End cap 34 also at least substantially covers an end of housing 24. End cap 34 may include endplate 46 to carry out this function at least partially. Endplate 46, generally in conjunction with the housing fastener, may at least substantially or completely cover an end of housing 24. In addition, endplate 46 may position housing fastener 32 relative to housing 24. Endplate 46 may be mounted on side wall portion 33 through direct physical engagement with second end region 38. As shown in FIG. 3, a perimeter 48 of the endplate may gripped by gripping structure 50 of side wall portion 33. For example, gripping structure 50 may grip some or all of perimeter 48 on opposing faces of endplate 46, and may also engage the side edge of the endplate. Gripping structure 50 may be present on either side wall portion 33, end cap 46, or both. Structure 50 generally may include any contact structure on either the side wall portion or end cap (or both) sufficient to stably mount the end cap by physical engagement, typically restricting the ability of end cap 34 to rotate and move axially.

Housing fastener 32 may be mounted on endplate 46. For example, endplate 46 may include a through-hole 52 through which housing fastener 32 extends. Through-hole 52 may define a perimeter that physically engages housing fastener 32. For example, a STRUX clinch stud, obtained from Camcar Textron, has been successfully used as housing fastener 32. This stud may be stably held in position after pressure mounting in through-hole 52 of endplate 46.

The shape and composition of the endplate may be determined by structural and/or functional considerations. Endplate 46 may be annular, generally in the form of a washer, or assume whatever shape allows the endplate to be mounted on the side wall portion and provide a mounting site for the housing fastener. Furthermore, endplate 46 may be nonplanar, with a concave cross-sectional profile, defined by offset 54. Offset 54 also may be annular, as shown in FIG. 3. Offset 54 is an example of a deformation limiting structure. A deformation limiting structure is any end cap structure that may protect endplate 46 from a tendency to deform in response to a centrally located axial force. Such a force may be produced when fasteners 30 and 32 are secured to external structures, which may tend to buckle endplate 46. Any deviation from a generally planar configuration for endplate 46 may provide a deformation limiting structure. The endplate may be produced from a strong, non-corrosive material such as stainless steel or aluminized steel.

End cap 34 may include a displacement limiting structure 60. Displacement limiting structure 60 is any physical barrier that blocks displacement of cushion 26 beyond the barrier. In mount 10, displacement limiting structure 60 is provided by the head of housing fastener 32. Alternatively, displacement limiting structure 60 may be distinct from housing fastener 32. For example, the displacement limiting structure may overlie the housing fastener or may be positioned laterally relative to the fastener.

Housing 24 positionally fixes a peripheral portion of elastomeric cushion 26 so that more central portions of the cushion deform. Elastomeric cushion 26 may be constructed from any material that is reversibly deforms in response to transient shear and compression forces. Cushion 26 may be formed of rubber or a similar elastomeric material using injection into a mold. For example, rubber may be injected under pressure when the rubber is in a liquid form and subsequently vulcanized to a durable form.

Cushion 26 is disposed at least substantially within housing 24, but in a spaced relation with end cap 34. The spaced relation produces an interior compartment 61 that generally is bounded by bottom surface 44 of the cushion and at least a central region of end cap 34. The central region may intersect central axis 29 and include structure 60 of fastener 32. In some embodiments, a peripheral region of bottom surface 44, near side wall portion 33, may contact the end cap.

The disposition, shape, and composition of the displaceable member may be determined by structural and/or functional considerations. Displaceable member 28 is attached to cushion 26, typically by embedding member 28 in the cushion during formation of the cushion. Member 28 may be disposed such that it is substantially coaxial with the housing, aligned with central axis 29. Suitable materials for member 28 may include high strength materials such as stainless steel and mild steel. Displaceable member 28 may take any form in which a first portion provides a surface that anchors the member to cushion 26 and a second portion provides member fastener 30. Generally, member 28 includes a second end section 62, a side section 64, and a first end section 66. Alternatively, member 28 may be described as including a cushion attachment surface 68 and a fastener portion 70. Attachment surface 68 typically includes a least a part of second end section 62 and side section 64. In the example of FIGS. 2-5, member 28 has an elongate structure with a hexagonal exterior surface. Attachment surface 68 of member 28 is embedded in cushion 26. Attachment surface 68 may also include at least one extension 72 that protrudes outward from side section 64. Extension 72 may be integrally formed in member 28 or may be provided by a separate structure, such as pin 74, which is inserted through a hole in attachment surface 68 and extends generally orthogonal to central axis 29 of mount 10.

Member fastener 30 is any structure that is capable of coupling member 28 to an external structure. In this example, fastener 30 is a threadable fastener, a nut, which includes an extended threaded portion having a long axis aligned with central axis 29. However, fastener 30 may be a bolt, or other attachment structure such as a bracket.

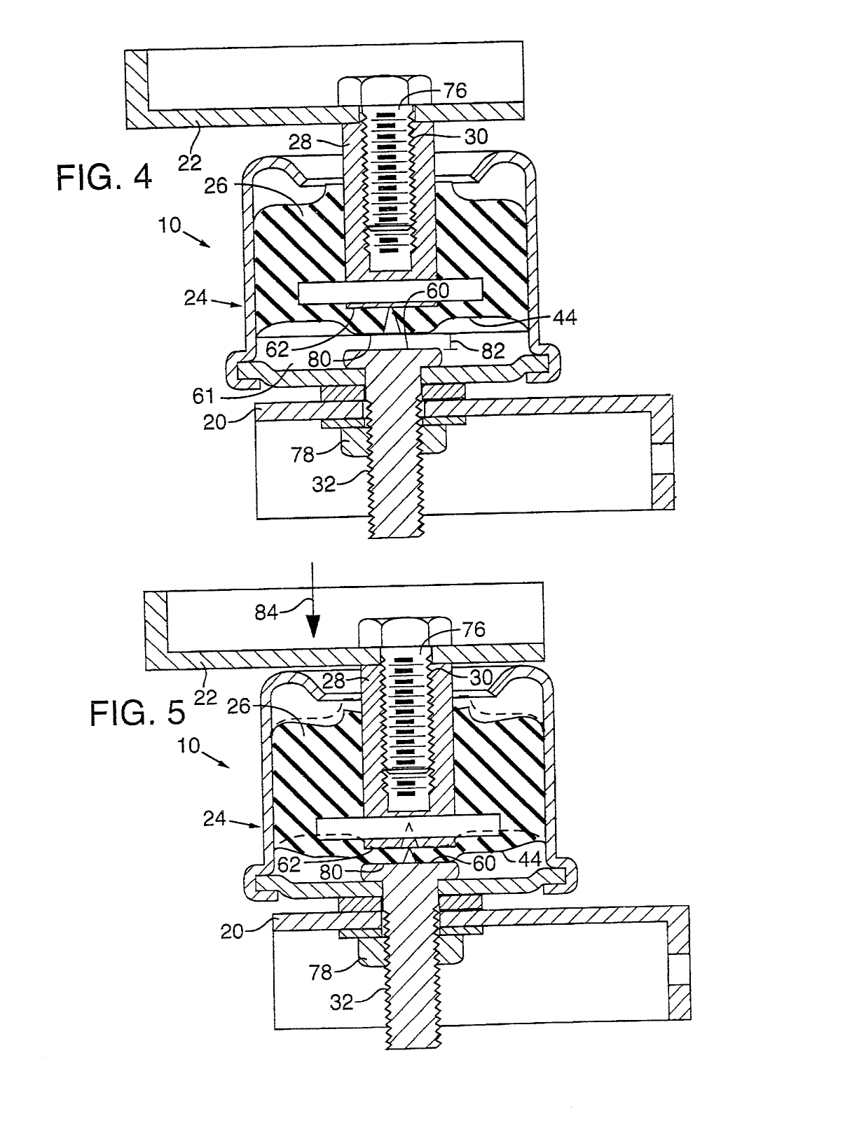

Cushioning action of shock mount 10 may be understood by comparing FIGS. 4 and 5. In FIG. 4, shock mount 10 is shown in a resting position, mounted between bottom and top brackets 20 and 22. Mount 10 is attached to top bracket 22 using member fastener 30, which is connected to bolt 76, and attached to bottom bracket 20 using housing fastener 32 and nut 78. In resting position, a central portion 80 of the cushion's bottom surface 44 is disposed in a spaced, opposing relationship to displacement limiting structure 60. Specifically, region 44 and structure 60 are separated by a limiting distance 82 defined by interior compartment 61.

FIG. 5 illustrates the effect of a downward vertical force 84 (arrow), exerted through bracket 22 to member 28 of mount 10. Force 84 displaces member 28 vertically within housing 24, deforming elastomeric cushion 26 downward from its resting position, shown as upper and lower dashed contours. With a sufficient downward force 84, such as in this example, downward displacement of central portion 80 of cushion 26 is limited by structure 60, usually through direct contact, as shown. Therefore, vertical displacement of member 28 by limiting distance 82 approximately defines the extent of movement of member 28 through which cushion 26 undergoes predominantly shear deformation. Once sufficient force is exerted for displacement of cushion 26 to be limited by structure 60, subsequent downward movement of member 28 mainly requires compression of cushion 26. Specifically, central portion 80 of the cushion is compressed between second end section 62 of member 28 and structure 60. Therefore, the overall result of increasing force may be a biphasic shock absorbing action in which member 28 first moves predominantly by shear deformation of cushion 26, and then predominantly by compressive deformation of cushion 26. A specific example of a biphasic curve is presented in FIG. 13 and will be discussed below. It will be understood that an upwardly directed force on member 28 also will produce significant shock absorption through cushion deformation.

Alternative Shock Mount Embodiment

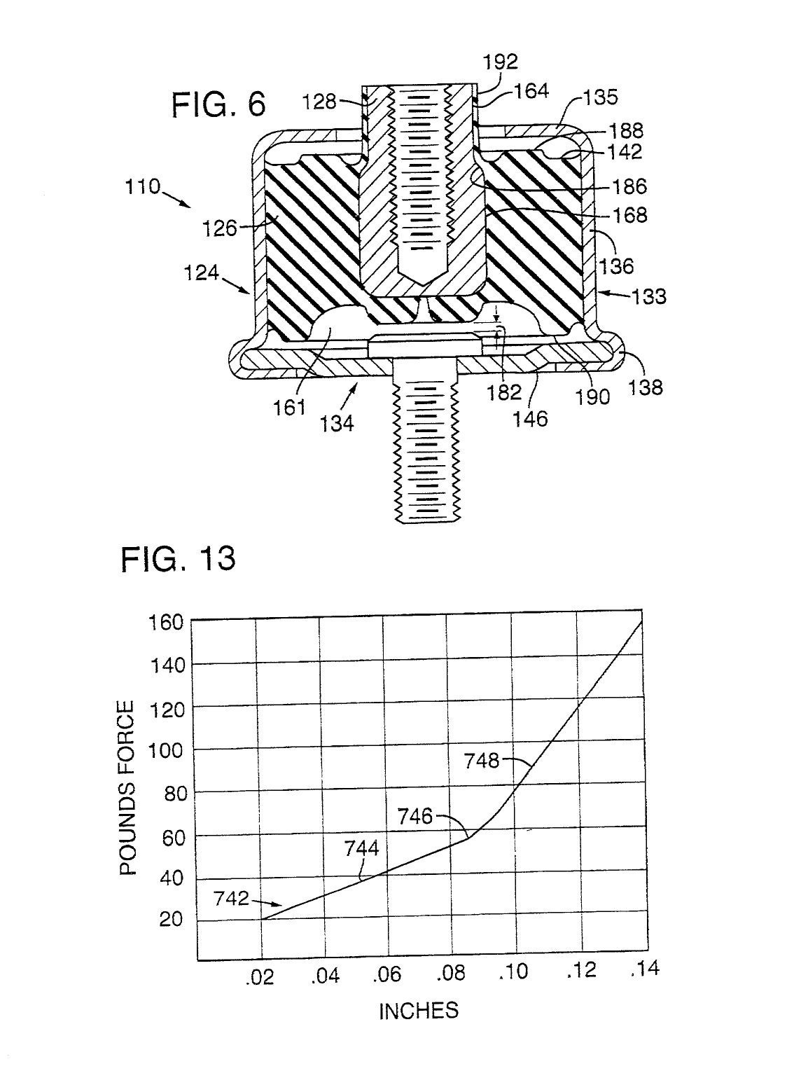

An alternative shock mount 110 is shown in FIG. 6. Shock mount 110 includes housing 124, cushion 126, and displaceable member 128. Housing 124 also includes end cap 134 joined to side wall portion 133, the end cap being similar in design to that used in shock mount 10. However, at least several aspects of shock mount 110 are distinct from mount 10.

Displaceable member 128 has a circular cross-sectional geometry (not shown) and includes a taper along side section 164 of attachment surface 168. Although a “step” taper 186 is shown in this example, a more gradual taper may be used. A taper, extension 72, or any other protruding or irregular structural aspect of the displaceable member that may improve retention in the cushion may be described as a member retention structure.

First end region 135 of housing 124 bends inward from central region 136, but differs from first end region 35 of mount 10 by extending in an orthogonal orientation relative to central region 136. First end region is spaced from, and generally opposed to, top surface 142 of cushion 126, forming a generally annular cavity.

Cushion 126 includes cushion-retention structures 188 and 190 that may be spaced closely from first end region 135 and endplate 146, respectively. In this example, the cushion-retention structures are positioned to retain cushion 126 within housing 124, through contact with first end region 135 and endplate 146, if attachment of cushion 126 to central region 136 is compromised. Thus, cushion-retention structures 188 and 190 may function in a fail-safe structure that may allow mount 110 to maintain mounting and partial shock-absorbing abilities under extreme operating conditions. Such extreme operating conditions may cause a peripheral portion of cushion 126 to slip relative to central region 136 of the housing.

Retention structures 188 and 190 also may be directly involved in shock absorption. For example, structure 188 may be spaced from the first end region 135 so that the structure and region are in contact after sufficient upward displacement of member 128. Once in contact, the force-displacement properties of the mount will change. Thus, this configuration may produce a biphasic or dual-rate shock absorption at the top of mount 110, similar to that produced at the bottom of the mount (see FIGS. 4, 5, and 13).

In the example of FIG. 6, first cushion-retention structure 188 is formed as a generally annular protrusion of top surface 142 of cushion 126, although multiple spaced protrusions may be used. In addition, any other configuration may be used for first end surface 142 that positions the cushion-retention structure at a short distance from the first end region of the housing, generally similar to limiting distance 182. Second cushion-retention structure 190 also may be formed as a generally annular protrusion, multiple spaced protrusions, or any other closely spaced structure that is positioned at a short distance from endplate 146, generally less than limiting distance 182. Alternatively, each cushion-retention structure may be engaged by a peripheral region of first end region 135 or endplate 146, when the shock mount is in a resting position, rather than spaced as shown in FIG. 6. In that case, the structures would assist in fixedly positioning a peripheral portion of the cushion, while still allowing more centrally located regions of cushion 126 to be deformed.

Cushion 126 extends upward, shown at 192, to cover, or at least substantially cover, side 164 of member 128. By covering side 164 with cushion 126, member 128 may be protected, for example from corrosion, and may also more efficiently engage cushion 126, due to increased surface engagement area. The cushion may extend over a surface area of the side of the member that is at least equal to a total area of engagement between the central region of the housing and the peripheral region of the cushion.

Examples of Alternative Fastener Assemblies

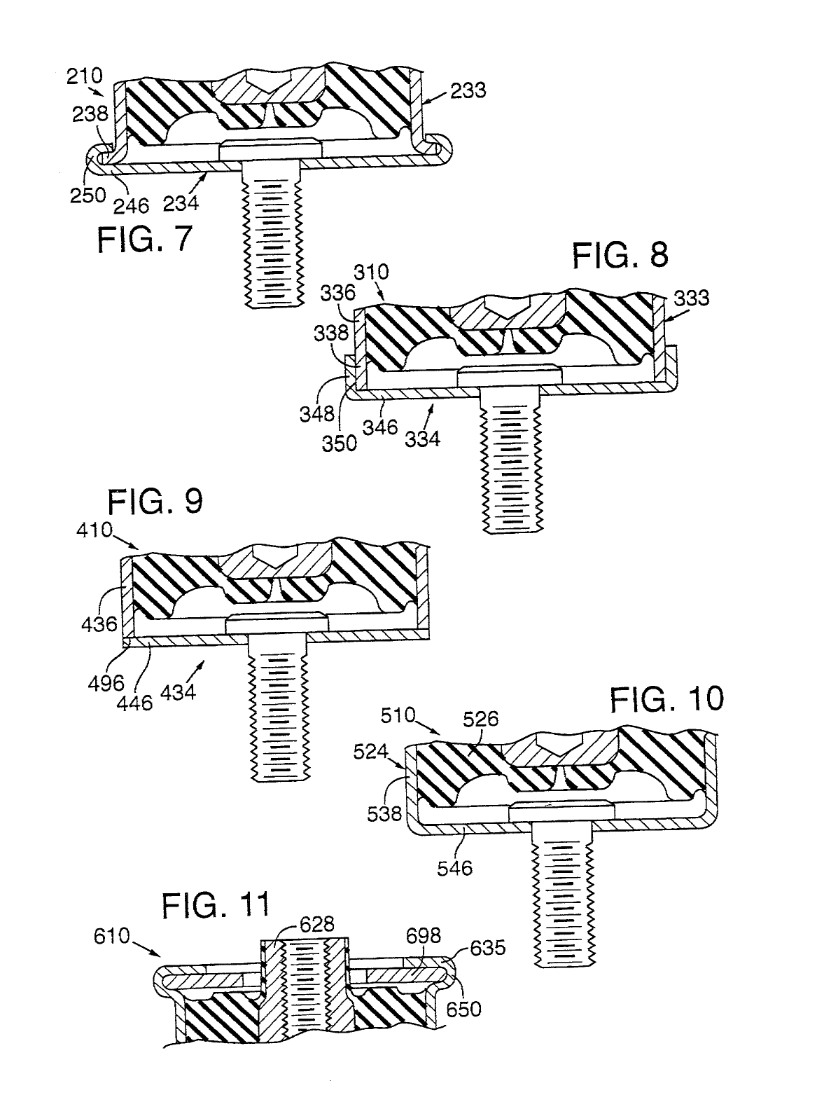

FIG. 7 shows an example of an alternative way to mount an end cap 234 to side wall portion 233 of the housing. In mount 210, gripping structure 250 is provided by a perimeter region of endplate 246, and grips a flange formed on second end region 238 of the side wall portion.

FIG. 8 illustrates an example of an attachment strategy for another end cap 334, included in mount 310. End cap 334 includes a perimeter 348 that extends orthogonally from a central portion of endplate 346 to produce a gripping structure 350 that engages second end region 338 of side wall portion 333. In some embodiments, structure 350 may use welding or adhesive bonding to promote stable mounting. As an alternative to the perimeter fitting outside of second end region 338, end cap 334 may be dimensioned to allow second end region 338 to tightly fit outside of perimeter 348. In either case, a face of second end region 338 is joined to a face of endplate 346.

FIG. 9 depicts an alternative mounting strategy for an end cap 434, shown in mount 410. In this example, a face of endplate 446 is joined to lower end 496 of the second end region. End cap 434 may be attached by any suitable approach such as welding or adhesive bonding.

As an alternative to joining separate components, FIG. 10 illustrates endplate 546 and second end region 538 that are joined by forming them integrally in mount 510. In this case, housing 524 may be produced by cold-forming an appropriately dimensioned sheet of metal, or may be molded or cast. Cushion 526 may be molded separately and then press-fit into housing 524.

FIG. 11 illustrates an example of endplate 698 mounted on first end region 635 in mount 610 and surrounding a portion of displaceable member 628. In this example, gripping structure 650 mounts a perimeter of endplate 698.

Methods of Fabricating a Shock Mount

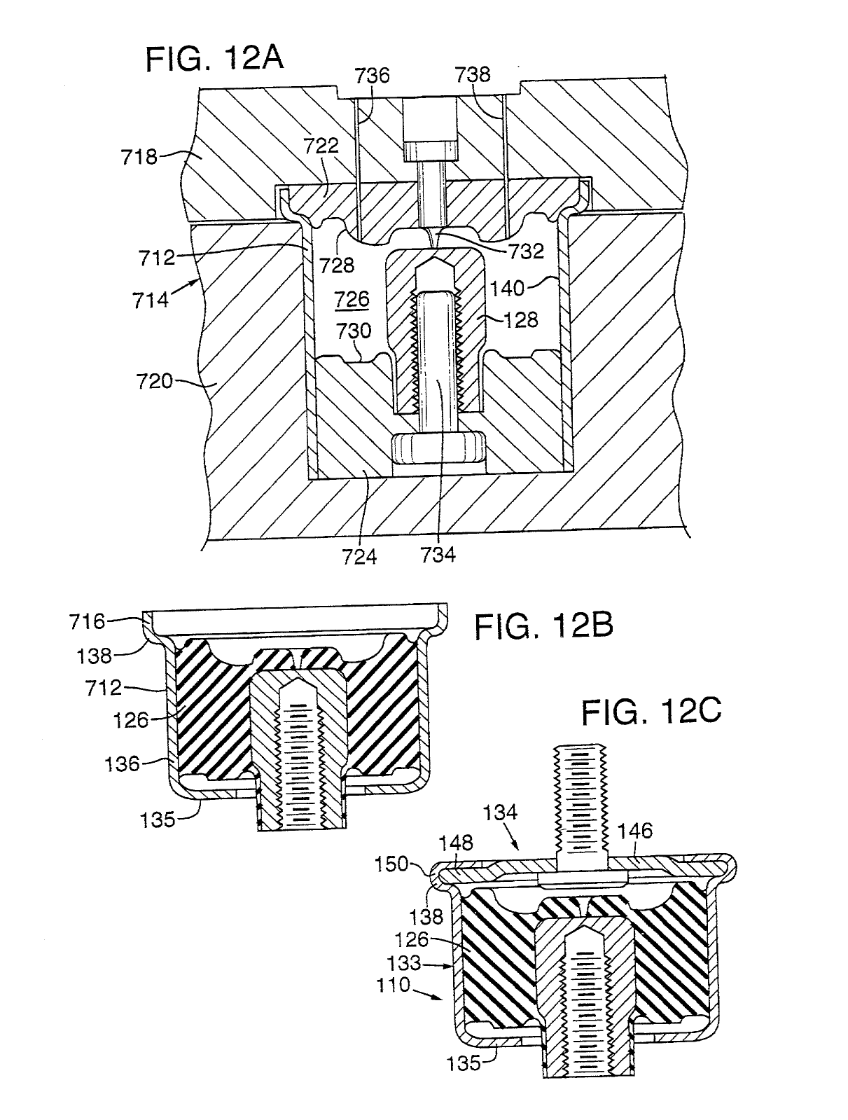

FIGS. 12A-C depict steps that may be carried out in constructing a mount according to the present invention. A method for construction of mount 110 (FIG. 6) is shown. In FIG. 12A, proto-housing 712 is shown positioned within mold 714. Proto-housing 712 may be formed from a cylinder, and may be otherwise unformed at this step. Alternatively, proto-housing 712 may include a partially formed gripping structure 716, such as shown in FIGS. 12A and 12B.

Mold 714 includes half blocks 718 and 720 into which first and second forms 722 and 724 may be attached by any suitable mechanism such as screws, bolts, an adhesive, or welding. Alternatively, each half block and form may be formed integrally. Chamber 726 may be produced by a surface 728 of first form 722, a surface 730 of second form 724, a surface of displaceable member 128, a portion of retainer 732, and interior region 140 of proto-housing 712. Member 128 may be held in place within chamber 726 by positioner 734 and retainer 732. Molten material may be injected into channel 736 and/or 738 under high pressure. Cushion 126 may be molded in an inverted configuration relative to FIG. 6.

Typically, rubber is used to form cushion 126. With rubber, an elevated temperature of approximately 350° F., and an increased pressure may be used to facilitate vulcanization of the rubber within the mold. Additionally, both interior surface 140 of proto-housing 712 and an exterior surface of member 128 may be prepared for rubber bonding. These surfaces may be chemically cleaned, then treated with a primer, such as Chemlock 205, and allowed to dry. Subsequently, the primed surfaces may be coated with a suitable adhesive, such as Chemlock 252, and the adhesive allowed to cure for two or more hours. This preparation may provide surfaces that tightly bond rubber during injection molding and vulcanization. Subsequent to forming cushion 26, mold 714 may be removed and proto-housing (side wall portion) 712 further shaped and modified. For example, first end region 135 may be formed. Alternatively, in some embodiments, partially formed gripping structure 716 may be shaped from second end region 138 at this step. End cap 134 then may be placed in position and gripping structure 150 completed by forming second end region 138 over perimeter 148 of endplate 146.

An alternative method may be used to form a shock mount with an integral endplate, such as exemplified in mount 510 of FIG. 10. A cushion may be molded around a displaceable member in a fashion similar to the configuration shown in FIG. 12A, but in the absence of a housing. This produces a cushion-member combination. The housing may be formed separately, for example, by cold-forming an appropriately dimensioned sheet of metal or by casting. Subsequently, the cushion-member combination may be press-fit inside the housing. Finally, the first end region of the housing may be formed as described for mount 110 above. The cushion may be adhesively bonded to the interior surface of the housing and/or the first end region or the endplate may be used to hold the cushion in position.

Example of Shock Mount Force-displacement

The following is an example of a force-displacement curve generated with a shock-absorbing mount according to the present invention. A shock mount was constructed according to the embodiment of FIG. 6 with the following general specifications: housing height, 36.9 mm; housing outer diameter, 50.8 mm; displaceable member diameter at first end portion, 15.9; and limiting distance, 2.16 mm or about 0.085 inches. The housing was constructed of 16 gage aluminized steel, with the exception of the endplate, which was formed from 12 gage aluminized steel. The displacement limiting structure/housing fastener 32 was provided by a STRUX clinch stud, ⅜″×1″, alloy steel, Grade 8, obtained from Camcar Textron. The cushion was formed of rubber with the following properties: ASTM D200 M4 CA514 B35 Z1 Z2 Z3; where Z1 is 55 durometer +/−5, Z2 is EPDM; and Z3 tension is set per D412 section 12.2 at 250° F., not to exceed 5%.

Displacement of member 128 along the central axis was measured using a varying, axially-aligned force of known magnitude. The biphasic curve 742 shown in FIG. 13 was obtained by plotting these measurements and drawing a continuous, best-fit curve. Curve 742 includes shear phase 744 at displacement of member 128 less than limiting distance 746, and compression phase 748 at displacement of member 128 greater than limiting distance 746, at about 0.085 inches.

The disclosure set forth above may encompass multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements. It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

I claim:

1. A device for dampening movement of an exhaust assembly mounted on a vehicle, comprising:
a housing having a side wall portion and an end cap, the side wall portion being joined to the end cap to form an interior surface;
an elastomeric cushion mounted on the interior surface, the cushion being at least partially spaced from the end cap, thereby forming an interior compartment; and
a displaceable member affixed to the cushion, wherein the member and the housing are adapted to move relative to each other through cushion deformation.

2. The device of claim 1, wherein the side wall portion and the end cap are formed of separate components.

3. The device of claim 2, wherein at least one of the side wall portion and the end cap includes a gripping structure that attaches the side wall portion to the end cap.

4. The device of claim 3, wherein the end cap defines a perimeter, and the gripping structure is included in the side wall portion and grips the perimeter.

5. The device of claim 1, wherein the member and housing include fasteners, and the fasteners are at least substantially aligned.

6. The device of claim 1, wherein the end cap includes a housing fastener and a generally annular endplate that defines an aperture with a perimeter, the housing fastener being mounted on the endplate by extending through the aperture and engaging the perimeter.

7. The device of claim 1, wherein the side wall portion includes a region that is at least substantially cylindrical.

8. The device of claim 1, wherein the side wall portion includes a generally converging end region distal to the end cap, the converging end region being at least partially spaced from the cushion to form a cavity.

9. The device of claim 1, wherein the housing has a housing fastener with a head, the head opposing a central portion of the cushion.

10. The device of claim 1, wherein the housing is formed at least substantially of metal.

11. A device for dampening movement of an exhaust assembly mounted on a vehicle, comprising:
a cup-shaped housing having a central axis, a side wall portion surrounding the central axis, and an end cap joined to the side wall portion, the end cap including a central region that intersects the central axis;
an elastomeric cushion disposed at least substantially within the housing and engaged by the side wall portion, the cushion being spaced from the central region, thereby forming an internal compartment; and
a displaceable member affixed to the cushion and disposed in spaced relation to the side wall portion and the end cap, wherein the member and the housing include fasteners adapted to move relative to each other through cushion deformation.

12. The device of claim 11, wherein the side wall portion and the end cap are formed of separate components.

13. The device of claim 11, wherein at least one of the side wall portion and the end cap includes a gripping structure that attaches the side wall portion to the end cap.

14. The device of claim 11, wherein the end cap includes the housing fastener and an endplate, the endplate defines an aperture with a perimeter, and the housing fastener extends through the aperture and engages the perimeter.

15. The device of claim 11, wherein the end cap includes an endplate, and the endplate has a deformation limiting structure.

16. A method of fabricating a device for dampening movement of an exhaust assembly mounted on a vehicle, comprising:
providing a displaceable member having a member fastener and further providing a proto-housing having a side wall portion that surrounds a central axis;
positioning an elastomeric cushion at least substantially inside the proto-housing and in contact with the displaceable member so that the cushion engages the side wall portion and the displaceable member is affixed to the cushion, at least substantially aligned with the central axis; and
joining an end cap to the side wall portion, wherein the end cap includes a housing fastener that opposes the member fastener.

17. The method of claim 16, wherein positioning is carried out by molding the cushion at least substantially inside the proto-housing.

18. The method of claim 16, wherein the end cap is joined after positioning the cushion.

19. The method of claim 16, wherein joining includes forming a gripping structure on at least one of the proto-housing and the end cap, the gripping structure being adapted to join the proto-housing and the end cap.

20. The method of claim 16, wherein the end cap includes an endplate that holds the housing fastener.

21. The method of claim 16, wherein the housing and member fasteners are at least substantially aligned with the central axis.
